(19) United States
(12) Patent Application Publication
(10) Pub. No.: US 2015/0105118 A1
(43) Pub. Date: Apr. 16, 2015

(54) Beach Public Address Wireless Early Warning System

(71) Applicant: Victor Tapia, Sunrise, FL (US)

(72) Inventor: Victor Tapia, Sunrise, FL (US)

(21) Appl. No.: 14/050,516

(22) Filed: Oct. 10, 2013

(51) Int. Cl. H04B 7/26; H04W 76/00

(52) U.S. Cl. CPC H04B 7/2625; H04W 76/007
USPC 455/521

(57) ABSTRACT

A beach public address wireless early warning system that is used by lifeguards or beach safety personnel to warn the beach going public of hazards at a beach. The public address warning system comprises of a remote life guard station that has the capacity to capture images of its surrounding and to warn the public of hazards via a loud speaker (the public address warning system) from a life guard base station that controls and monitors the equipment of the remote life guard station via a radio frequency signal. The beach public address wireless warning system can provide WiFi capabilities to the beach public.

### BACKGROUND

The present invention relates to a beach public address wireless early warning system that uses Internet Protocol and/or wireless frequencies to alert beach goers of a hazard from a base station (it can be a headquarters of a life guard monitoring body) that monitors remote life guard stations.

The inventor of the present invention is an engineer working on a wireless environment. By hearing a comment from an associate and a life guard about people dying from lightning striking at the water, in Clear Water Beach Florida, “it would be nice if there was a Public Address System at the beach to warn people to get out of the water in time and out of danger”. He realized that a wireless PA system could be designed to warn people not just near the water at the beach hut anywhere needed.

The inventor realized that for the Wireless PA System to be installed in lifeguard stands at the beach, the system would have to be self powered. The inventor first decided to design a solar power system with solar panels, producing enough wattage of power to charge a battery, to power the PA system amplifier, loud speaker, switch, transmitter and cameras for days even on cloudy days.

This is when the inventor realized that solar powered wireless PA Internet Protocol system could be used, not just at the beach, but anywhere needed to warn citizens from immediate danger,

The inventor further realized that if the solar wireless PA system was transmitting and receiving the Internet Protocol (IP), the Wireless PA system could be addressed locally as well as from anywhere in the world via the Internet,

### SUMMARY

The present invention is directed to be used for public safety in public and private places where a Solar Wireless PA system, video surveillance and wireless internet may be needed, ex: beaches, campuses, parks, parking lots, car lots, streets, police stands, etc.

A Wireless Early PA System that attaches to remote structures with AC power or having solar panels, a charge controller, wireless transmitter/receiver, a switch, a public address amplifier, a loud speaker, cameras and batteries.

The present invention comprises a rectangular hermetically sealed outdoor unit that contains the charge controller for the solar panels, that power the present invention, a PA amplifier, and a switch with ports. The battery is also in a self contained box. The solar panels derive three solid wires to the charge controller, from the charge controller power is routed to charge the battery and from the battery power for the devices. The outdoor box and the battery box can be attached to any structure with stainless steel screws or be secured to the structure using industrial cable ties. The cameras, the loud speaker and the transmitter/receiver can be installed conveniently to monitor the area and to aim the loud speaker to the area that needs to be addressed. The transmitter/receiver connects wireless to the base station and in turn the base station is connected to the local network as well as to the Internet. The internet protocol from the devices connects o the switch, and the switch connects to the transmitter to transmit the data to the base station. A software application is loaded into the computers connected to the network with the base, a software application can also be loaded in wireless laptop computers and other devices that can connect directly to the wireless base to use the software application to address the wireless PA system directly from these devices and allowing the PA system to be addressed from many authorized devices or authorized networks locally or anywhere.

Exemplary embodiments of the present invention solves the problems in the art of providing a wireless public address system, method, and computer software code for enabling the wireless public address system at public beaches. Persons skilled in the art will recognize that an apparatus, such as a data processing system, including a CPU, memory, I/O, program storage, a connecting bus, and other appropriate components, could be programmed or otherwise designed to facilitate the practice of the method of an exemplary embodiment of the invention. Such a system would include appropriate program means for executing exemplary embodiments of the invention

Broadly speaking, the technical effect is enabling a wireless public address system, thereby improving public address wireless warning system at beaches. The invention may be described in the general context of computer-executable instructions, such as program modules, being executed by a computer, Generally, program modules may include routines, programs, objects, components, data structures, etc., that perform particular tasks or implement particular abstract data types. For example, the software programs that underlie exemplary embodiments of the invention can be coded in different languages, for use with different computing platforms. It will be appreciated, however, that the principles that underlie exemplary embodiments of the invention can be implemented with other types of computer software technologies as well.

Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

An object of the present invention is to provide a sophisticated tool for early warning system for beaches, parks, campuses, schools or any remote sites that needs to set up a quick and effective Solar Wireless PA Early Warning System

An object of the present invention is to provide public safety where the police and pubic agencies can monitor property and use the PA system to address and prevent potential crimes and other safety issues.

Another object of the present invention is to provide a way to use the wireless loud speaker and the cameras in the PA system to locate lost children, demented elderly and all other people that may be lost at the beach or public places where thousands of people may be gathered.

Another object of the invention is to provide the means to use the public at large in the areas where the Wireless Early Warning System is installed, to help locate a missing child for example, if the life guards at the beach are looking for a missing child and use the PA system to announce the event, then all beach goers can look for the child.

A further object of the invention is to provide wireless internet access via Wi Fi at the remote location via the wireless transmitter/receiver.

Other objects of the invention will become apparent as other applications are thought out by the users of the system and in view of the following description taken in connection with the accompanying drawings.

### DRAWINGS

These and other features, aspects, and advantages of the present invention will become better understood with regard to the following description, appended claims, and drawings where:

FIG. 1 is an overview diagram of the present invention.

### WRITTEN DESCRIPTION

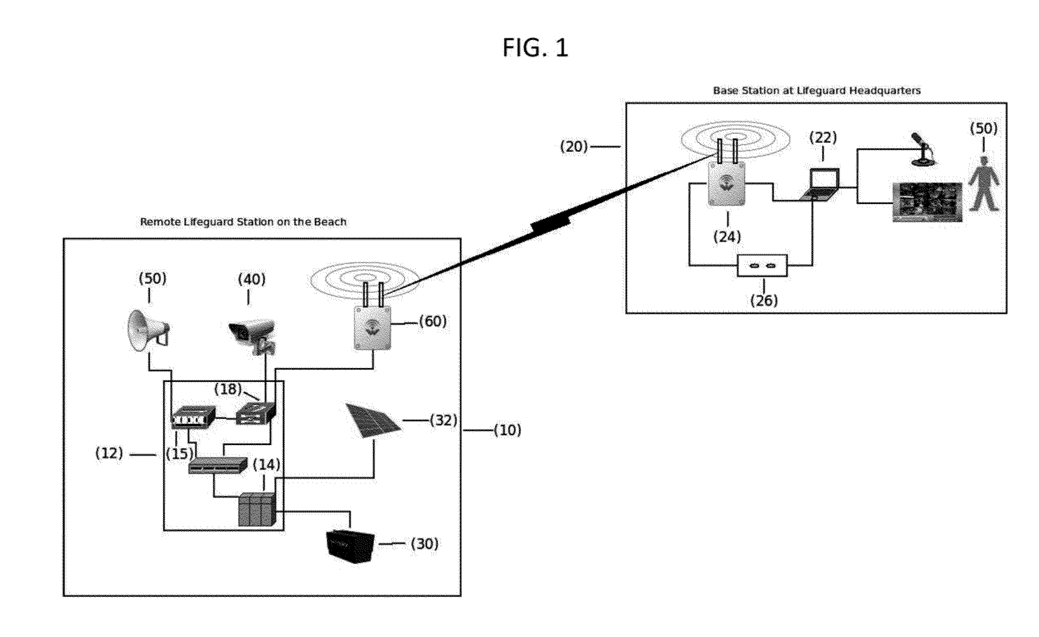

As seen in FIGS. 1, a beach public address wireless warning system that is used by lifeguards to warn the beach going public of hazards at a beach, the public address warning system comprises of at least one remote life guard station 10 and a life guard base station 20.

The remote life guard station 10 comprises of: a hermetically sealed outdoor unit 12 that houses a charge controller 14, a public address amplifier 15, and a switch with ports 18, the public address amplifier 15 is connected to the switch with ports 18; a battery 30 connected to the charge controller 14; at least one solar panel 32 connected to the charge controller 14; at least one loud speaker 50 connected to the public address amplifier 15; and a wireless transmitter/receiver 60 connected to the switch with ports 18, the wireless transmitter/receiver 60, the switch with ports and the public address amplifier 15 are powered by the battery 30.

The life guard base station 20 that monitors and sends signals to each remote life guard station 10 comprises: a radio frequency transmitter/receiver 24; a computer 22, the computer 22 having a plurality of program modules that communicate with a plurality of peripheral devices at each remote life guard station 10, the radio frequency transmitter/receiver 24 is connected to the computer 22 and connects to each remote lifeguard station 10 wirelessly, the computer has an interface (not shown in figures) that allows a user 25 to send an instruction to each remote life guard station 10; and a power source 26 that powers the computer 22 and the radio frequency transmitter/receiver 24.

In another embodiment of the present invention, each remote life guard station 10 may further comprise of at least one video camera 40 connected to the switch with ports 18, the camera is powered by the battery 30.

In still another embodiment of the present invention, the wireless transmitter/receiver 60 of each remote life guard station 10 is Wi Fi enabled.

The present invention is installed at beaches as follows: by providing a beach; by providing at least one life guard station at each beach; by providing at least one life guard base station; by installing at each life guard station 10: a hermetically sealed outdoor unit 12 that houses a charge controller 14, a public address amplifier 15, and a switch with ports 18; a battery 30 connected to the charge controller 14; at least one solar panel 32 connected to the charge controller 14; at least one loudspeaker 50 connected to the public address amplifier 15; a wireless transmitter/receiver 60 connected to the switch with ports 18, the wireless transmitter/receiver 60, the switch with ports 18 and the public address amplifier 15 are powered by the battery 30; and by installing at the base station 20: a radio frequency transmitter/receiver 24; a computer 22, the computer 22 having a plurality of program modules that communicate with a plurality of peripheral devices at each remote life guard station 10, the radio frequency transmitter/receiver 24 is connected to the computer 22 and connects to each remote lifeguard station 10 wirelessly, the computer has an interface that allows a user 25 to send an instruction to each remote life guard station 10; and a power source 26 that powers the computer 22 and the radio frequency transmitter/receiver 24.

In another embodiment of installing the present invention, at least one video camera 40 may be connected to the switch with ports 18 at each remote life guard station 10, each camera is powered by the battery 30.

In still a further embodiment of installing the present invention, Wi-Fi capacity at each remote life guard station may be provided.

Embodiments of the present invention use outdoor enclosures made of weather resistant materials. In a preferred embodiment, the invention would be made of a resilient fiber glass and a polyester compound.

The present invention uses a wireless circuit for the video to be transmitted to the base station from the cameras, then from the computer connected to the base station data is transmitted to the remote station for the public address system and for the Wi Fi Internet access.

An advantage of the present invention is that it provides a secure wireless system that can monitor a beach with the cameras

Another advantage of the present invention is that it provides a way to address the public via the wireless public address system.

Another advantage of the present invention is that it provides wireless internet access to the public enjoying the beach.

Another advantage of the present invention is that it provides a wireless connection that can be used for a two way transmission for any Internet Protocol services between the remote station and the base station.

A further advantage of the present invention is that it provides an encrypted secure wireless connection between the remote station and the base station.

While we have shown and described the embodiment in accordance with the present invention, it should be clear to those skilled in the art that further embodiments may be made without departing from the scope of the present invention.

What is claimed is:

1. A beach public address wireless warning system that is used by lifeguards to warn the beach going public of hazards at a beach, the public address warning system comprises of:
At least one remote life guard station 10, each remote life guard station 10 comprises:
A hermetically sealed outdoor unit 12 that houses a charge controller 14, a public address amplifier 15, and a switch with ports 18, the public address amplifier 15 is connected to the switch with ports 18;
A battery 30 connected to the charge controller 14;
At least one solar panel 32 connected to the charge controller 14;
At least one loud speaker 50 connected to the public address amplifier 15; and
A wireless transmitter/receiver 60 connected to the switch with ports 18, the wireless transmitter/receiver 60, the switch with ports and the public address amplifier 15 are powered by the battery 30; and
A life guard base station 20 that monitors and sends signals to each remote life guard station 10, each life guard base station 20 comprises:
A radio frequency transmitter/receiver 24;
A computer 22, the computer 22 having a plurality of program modules that communicate with a plurality of peripheral devices at each remote life guard station 10, the radio frequency transmitter/receiver 24 is connected to the computer 22 and connects to each remote lifeguard station 10 wirelessly, the computer defines an interface that allows a user 25 to send at least one instruction to each remote life guard station 10; and
A power source 26 that powers the computer 22 and the radio frequency transmitter/receiver 24.

2. The beach public address warning system of claim 1, wherein each remote life guard station 10 further comprises of at least one video camera 40 connected to the switch with ports 18, each camera is powered by the battery 30.

3. The beach public address warning system of claim 2, wherein the wireless transmitter/receiver 60 of each remote life guard station 10 is Wi-Fi enabled.

4. A method of installing a beach public address warning system at beaches, comprising the steps of
Providing a beach;
Providing at least one life guard station at each beach;
Providing at least one life guard base station;
Installing at each life guard station:
A hermetically sealed outdoor unit that houses a charge controller, a public address amplifier, and a switch with ports;
A battery connected to the charge controller;
At least one solar panel connected to the charge controller;
At least one loudspeaker connected to the public address amplifier;
A wireless transmitter/receiver connected to the switch with ports 18, the wireless transmitter/receiver 60, the switch with ports and the public address amplifier 15 are powered by the battery 30; and
Installing at the base station:
A radio frequency transmitter/receiver 24;
A computer 22, the computer 22 having a plurality of program modules that communicate with a plurality of peripheral devices at each remote life guard station 10, the radio frequency transmitter/receiver 24 is connected to the computer 22 and connects to each remote lifeguard station 10 wirelessly, the computer has an interface that allows a user 25 to send at least one instruction to each remote life guard station 10; and
A power source 26 that powers the computer 22 and the radio frequency transmitter/receiver 24.

5. A method of installing a beach public address warning system at beaches of claim 4, further comprising the steps of installing at least one video camera connected to the switch with ports at each remote life guard station, each camera is powered by the battery.

6. A method of installing a beach public address warning system at beaches of claim 5, further comprising the steps of providing a Wi-Fi capacity at each remote life guard station.
